(19) United States
(12) Patent Application Publication
(10) Pub. No.: US 2006/0020057 A1
(43) Pub. Date: Jan. 26, 2006

(54) Multi-modal particle size distribution resin dispersions

(76) Inventors: Joost Hubert Maas, Rotterdam (NL); Jacobus Gillis de Hullu, Wolphartsdijk (NL)

Correspondence Address: Polly C. Owen;Eastman Chemical Company, P.O. Box 511, Kingsport, TN, 37662-5075, US

(21) Appl. No.: 10/895,779

(22) Filed: Jul. 21, 2004

(51) Int. Cl. C08K 7/00

(52) U.S. Cl. 523/220

(57) ABSTRACT

A multi-modal particle size distribution resin dispersion is provided comprising a first resin dispersion and a second resin dispersion; wherein said second resin dispersion has a particle size sufficient to fit into the interstitial voids of said first resin dispersion. Processes to produce the multi-modal particle size distribution resin dispersion is also provided.

### FIELD OF THE INVENTION

This invention is related to the field of resin dispersions having a multi-modal particle size distribution. More specifically, an embodiment of this invention is related to a multi-modal particle size distribution resin dispersion comprising a first resin dispersion and a second resin dispersion; wherein the second resin has a particle size sufficient to fit into the interstitial voids of the first resin dispersion.

### BACKGROUND OF THE INVENTION

The use of resin dispersions with controlled particle size distributions is gaining more and more attention because the controlled particle size distribution can help to control rheology, can minimize solvent usage, and can control viscosity of the resin dispersion.

Polymer emulsions with bimodal or multi-modal particle size distributions are usually prepared by introducing small amounts of at least one polymer seed during the emulsion polymerization. However, single step processes can also be utilized. Resin dispersions are usually made by mixing resin, water, and surfactants. Dispersions can be produced directly where high shear forces create small particles of resin in the continuous phase. Resin dispersions can also be prepared in an indirect method where the resin is the continuous phase and water is added. During the addition of water, the system inverts into an oil-in-water dispersion. Generally, the particles formed in the direct and indirect methods have mono-modal particle size distributions.

While recent improvements in resin dispersion production processes have increased the solids content somewhat, none of the processes completely achieve a consistent solids content above about 60-65 weight percent solids using bimodal or multi-modal particle size distributions. Blending two or more resin dispersions with different particle sizes does not give the high solids advantage.

There is a need in the adhesive industry for resin dispersions having a multi-modal particle size distribution that can control rheology, minimize solvent usage or control viscosity of the resin dispersion.

### BRIEF SUMMARY OF THE INVENTION

This invention provides a multi-modal particle size distribution resin dispersion and processes for producing the multi-modal particle size distribution resin dispersion. In one embodiment, the multi-modal particle size distribution resin dispersion has a solids content greater than 60% by weight.

In accordance with one embodiment of the invention, a multi-modal particle size distribution resin dispersion is provided. The multi-modal particle size distribution resin dispersion comprises a first resin dispersion and a second resin dispersion; wherein the second resin dispersion has a particle size sufficient to fit into the interstitial voids of the first resin dispersion.

In accordance with another embodiment of the invention, a process for producing a multi-modal particle size distribution resin dispersion is provided. The process comprises contacting a first resin dispersion and a second resin dispersion; wherein the second resin dispersion has a particle size sufficient to fit into the interstitial voids of the first resin dispersion.

In accordance with another embodiment of the invention, a process for producing a multi-modal particle size distribution resin dispersion is provided. The process comprises: a) contacting a first resin, at least one surfactant, and water to produce a first resin dispersion; and b) adding a second resin dispersion to the first resin dispersion to produce the multi-modal particle size distribution resin dispersion; wherein the second resin dispersion has a particle size sufficient to fit into the interstitial voids of the first resin dispersion.

In accordance with yet another embodiment of the invention, a process to produce a multi-modal particle size distribution resin dispersion is provided. The process comprises contacting a first resin, at least one surfactant, water, and a second resin dispersion to produce the multi-modal particle size distribution resin dispersion; wherein the second resin dispersion has a particle size sufficient to fit into the interstitial voids of the first resin dispersion.

### DETAILED DESCRIPTION

A multi-modal particle size distribution resin dispersion comprising a first resin dispersion and a second resin dispersion is provided; wherein the second resin dispersion has a particle size sufficient to fit into the interstitial voids of the first resin dispersion. The term “resin dispersion” as used in this disclosure means a stable heterogeneous system of resin droplets in water. The resin phase is referred to as the dispersed, internal, or discontinuous phase. The surrounding water is called the external or continuous phase. Generally, the resin droplets are less than one micron in size.

The first resin can be any resin known in the art that can yield the properties desired in the multi-modal particle size distribution resin dispersion. Generally, the first resin can be selected from the group consisting of rosins, rosin derivatives, rosin esters, hydrocarbon resins, synthetic polyterpenes, natural terpenes, terpene phenolics, and the like. More particularly, useful first resins include, but are not limited to, (1) natural and modified rosins and the hydrogenated derivatives thereof; (2) esters of natural and modified rosins and the hydrogenated derivatives thereof; (3) polyterpene resins and hydrogenated polyterpene resins; (4) terpene phenolics and derivatives thereof; (5) aliphatic petroleum hydrocarbon resins and the hydrogenated derivatives thereof; (6) aromatic hydrocarbon resins and the hydrogenated derivatives thereof; and (6) alicyclic petroleum hydrocarbon resins and the hydrogenated derivatives thereof. Mixtures of two or more of the above-described first resins may be used for some formulations. Preferably, the first resin is at least one rosin ester or at least one hydrocarbon resin.

Rosin is a general name indicating the various natural resins obtained from pine trees. Natural and modified rosins and the hydrogenated derivatives thereof include, but are not limited to, gum rosin, wood rosin, tall-oil rosin, distilled rosin, hydrogenated rosin, dimerized rosin, and polymerized rosin.

Wood rosin is extracted from pine tree roots, and gum rosin is extracted from incisions in the trunk of pine trees. Tall oil rosin is extracted from raw paper pulp. The major components of rosin are the so-called rosin acids. The most common ones are abietic acid and primaric acid. Other rosin acids found in rosin include, but are not limited to, levopimaric acid, neoabietic acid, dehydroabietic acid, tetrahydroabietic acid, isopimaric acid, and palustric acid with very minor amounts of other related acids also being present. The rosin can comprise any of the various rosin acids typical of rosin.

In order to obtain a first resin with the desired properties, rosin acids can be modified by a number of reactions to produce a modified rosin. Disproportionation, hydrogenation, and esterification or a combination of the foregoing organic reactions can be used to modify rosins. Suitable examples of esters of natural and modified rosins and the hydrogenated derivatives thereof include, but are not limited to, the glycerol ester of rosin, the glycerol ester of hydrogenated rosin, the glycerol ester of polymerized rosin, the pentaerythritol ester of hydrogenated rosin.

Polyterpene resins generally result from the polymerization of terpene hydrocarbons, such as the bicyclic monoterpene known as pinene, in the presence of Friedel-Crafts catalysts at moderately low temperatures. Preferably, the polyterpene resins have a softening point, as determined by ASTM method E28-58T, ranging from about 80° C. to about 150° C.

Aliphatic petroleum hydrocarbon resins and hydrogenated derivatives thereof are generally produced from the polymerization of monomers consisting of primarily olefins and diolefins. Preferably, the aliphatic petroleum hydrocarbon resins have a Ring and Ball softening point ranging from about 70° C. to about 135° C.

Aromatic hydrocarbon resins include, for example, hydrocarbon resins derived from at least one alkyl aromatic monomer, such as, for example, styrene, alpha-methyl styrene, vinyl toluene, and the hydrogenated derivatives thereof. The alkyl aromatic monomers can be obtained from petroleum distillate fractions or from non-petroleum feedstocks, such as, for example, feedstocks produced from phenol conversion processes. Preferably, the aromatic hydrocarbon resins have a Ring and Ball softening point from about 0° C. to about 160° C.

Alicyclic petroleum hydrocarbon resins can be produced utilizing a hydrocarbon mixture comprising dicyclopentadiene as the monomer. Preferably, the alicyclic petroleum hydrocarbon resins have a Ring and Ball softening point from about 90° C. to about 150° C.

The particle size range of the first resin dispersion can range from about 200 to about 2000 nm, preferably from about 300 nm to 1000 nm, and most preferably, from 350 nm to 500 nm. All particle sizes mentioned in this disclosure are defined as the predominant diameter present in a peak of the particle size distribution measured by dynamic light scattering. For example, particle size of the resin dispersions can be measured by a Microtrac Particle Analyzer obtained from Leeds & Northrup Company having model number 9340-O-0-1-2-O-0 and serial number 9346-219605 and using direction book number 277832 and calibration data 9342-006.

Generally, the amount of solids in the first resin dispersion can range from about 30% by weight to about 75% by weight, preferably from 50% by weight to 65% by weight.

Generally, the amount of surfactant in the first resin dispersion can range from about 1% by weight to about 15% by weight, preferably from 5% by weight to 10% by weight.

Generally, the amount of water in the first resin dispersion can range from about 20% by weight to about 70% by weight, preferably from 30% by weight to 50% by weight.

The second resin can be any of the resins discussed for the first resin except the second resin dispersion has a particle size sufficient to fit into the interstitial voids of the first resin dispersion. In one embodiment, the particle size of the second resin dispersion ranges from about 50 to about 500 nm, preferably from about 75 to about 400 nm, and most preferably, from 100 nm to 300 nm.

The softening point of the first and second resins can range from about 30° C. to about 160° C., preferably from about 40° C. to about 120° C., and most preferably, from 50° C. to 90° C. as measured by ASTM E-28-96. The first and second resins can include resins having higher softening points that have been blended with additives, such as, for examples, oils and/or plasticizers, to decrease the softening point of the resin.

The acid number of the first and second resins can range from 0 to about 200 gram potassium hydroxide per gram of resin, preferably from about 10 to about 160 g KOH/g resin, and most preferably, from 15 to 70 g KOH/g resin. The acid number is defined as the number of milligrams of KOH that are required to neutralize one gram of sample. Acid numbers are obtained by titrating weighed samples dissolved in a solvent with potassium hydroxide using phenolphthalein as an indicator. End points are determined when the pink color of the indicator remained for about 10 seconds.

The amount of the second resin can range from about 0.1% by weight to about 40% by weight, preferably from 10% by weight to 30% by weight based on the weight of the total solids in the multi-modal particle size distribution resin dispersion.

Spheres of uniform size can be theoretically arranged in different ways. In a closed packing of spheres of the same size, either in face centered cubic or hexagonal closed packing, the maximum volume fraction of the spheres is approximately 74. The interstitial voids in a closed packing of spheres are tetrahedral voids formed by the face-centered packing of four large particles. The small particles of the second resin dispersion can fill the interstitial voids of the first resin dispersion, and thereby, the total volume of the combined spheres of both the first resin dispersion and the second resin dispersion can be increased above the maximum of the closed packing of the first resin dispersion.

The volume of the interstitial voids of the first resin dispersion is a function of the particle size of the first resin dispersion. When the size ratio of the particles of the first resin dispersion to the particles of the second resin dispersion is 4.5:1, a particle of the second resin can fill the interstitial void between the particles in the first resin dispersion. Increasing the size of the particles of the first resin dispersion can result in interstitial voids that can be filled with one or more particles from the second resin dispersion.

In another embodiment, the multi-modal particle size distribution resin dispersion comprises: (1) a first resin; wherein the first resin comprises at least one rosin having an acid number ranging from about 50 to about 150 and a softening point of from about −25° C. to about 150° C., (2) at least one surfactant in an amount ranging from about 0.1% to about 15% by weight of the total solids of the first resin, (3) water, and (4) a second resin dispersion in an amount ranging from about 1% to about 40% by weight of the total solids of the multi-modal particle size distribution resin dispersion; wherein the particles of the second resin dispersion fit in the interstitial voids of the first resin dispersion.

In one embodiment of this invention, the multi-modal particle size distribution resin dispersion has a solids content greater than about 60% by weight, preferably about 60% to about 80%, and most preferably, from 60% to 75%.

The first and second resin dispersions can be produced by any method known in the art to produce resin dispersions. Generally, to produce a resin dispersion, resin, at least one surfactant, and water are mixed. Various mechanisms and equipment configurations can be utilized to produce resin dispersions. For example, resin dispersions can be produced through a process using either a direct method or an invert method. The process can be batch, semi-continuous, or continuous in nature.

These methods can range from total solvent systems to solvent-assisted systems to solvent-less systems (100% water-based). In a total solvent system, resin is dissolved in a hydrocarbon solvent and used in a solvent medium. In a solvent-assisted system, resin is cut in a hydrocarbon solvent at a minimum level required to assist the emulsification and is subsequently added to water. The solvent can then be stripped to an acceptable level.

In a process which utilizes the direct method, a resin-in-water emulsion is created through use of equipment which induces high shear forces on a resin-water mixture, such as a homogenizer, a pebble-mill, Cowels mixer or high speed impeller. This equipment in addition to being able to induce high shear force may also be capable of generating high pressures and temperatures. For example, pressures ranging from about 1,000 psig to about 8,000 psig, and temperatures ranging from about 25° C. to about 200° C. can be produced.

In a process which utilizes the invert method, also known as chemical inversion, a water-in-resin mixture is initially prepared by suspending water droplets in a continuous resin phase. In a subsequent step, additional water is added to the water-in-resin mixture causing it to invert. The inverted mixture contains resin droplets dispersed in a continuous aqueous phase.

The surfactant used to make resin dispersions can be any conventional surfactant or a combination of surfactants known in the art. Generally, the surfactant is at least one selected from the group consisting of an anionic surfactant and a non-ionic surfactant. Examples of preferred surfactants include, but are not limited to, alkali alkyl sulfates, alkyl sulfates, alkyl sulfonic acids, fatty acids, alkyl phenol ethoxylates, sulfosuccinates and derivatives, and mixtures thereof. A list of suitable surfactants is available in the treatise: McCutcheon's Emulsifiers & Detergents, North American Edition, MC Publishing Co., Glen Rock, N.J., 1997. Preferably, the surfactant provides droplet/particle stability, but results in minimal aqueous phase nucleation (micellar or homogeneous).

In another embodiment of this invention, a process for producing the multi-modal particle size distribution resin dispersion is provided. The process for producing a multi-modal particle size distribution resin dispersion comprises contacting a first resin dispersion and a second resin dispersion; wherein the second resin dispersion has a particle size sufficient to fit into the interstitial voids of the first resin dispersion. The contacting can be completed by any method known in the art. The first and second resin dispersions were previously described in this disclosure.

In another embodiment of this invention, a process for producing the multi-modal particle size distribution resin dispersion is provided. The process comprises: a) contacting at least one first resin, at least one surfactant, and water to produce a first resin dispersion; and b) adding a second resin dispersion to the first resin dispersion to produce the multi-modal particle size distribution resin dispersion; wherein the second resin dispersion has a particle size sufficient to fit into the interstitial voids of the first resin dispersion.

Step (a) comprises contacting a first resin, at least one surfactant, and water to produce a first resin dispersion. To produce the first resin dispersion, the first resin is contacted with at least one surfactant and water by any method known in the art to produce the first resin dispersion. For example, a direct method or inversion (indirect) method can be utilized as discussed previously in this disclosure. The types and amounts of the first resin and surfactant were previously discussed in this disclosure.

Step (b) comprises adding a second resin dispersion to the first resin dispersion to produce the multi-modal particle size distribution resin dispersion; wherein the second resin dispersion has a particle size sufficient to fit into the interstitial voids of the first resin dispersion. The second resin was previously discussed in this disclosure.

In another embodiment of this invention, a process is provided to produce the multi-modal particle size distribution resin dispersion. The process comprises contacting a first resin, at least one surfactant, water, and a second resin dispersion to produce the multi-modal particle size distribution resin dispersion; wherein the second resin dispersion has a particle size sufficient to fit into the interstitial voids of said first resin dispersion. The first resin, surfactant, and second resin dispersion were previously described in this disclosure.

In another embodiment of this invention, a process is provided to produce the multi-modal particle size distribution resin dispersion. The process comprises:
1) heating a first resin beyond its glass transition temperature to produce a molten first resin; wherein the first resin comprises at least one rosin having an acid value ranging from about 50 to about 150 and a softening point ranging from about −25° C. to about 150° C.;
2) adding at least on surfactant to the molten first resin in an amount ranging from about 0.1% to about 15% by weight based on the weight of the total solids in the first resin to produce a resin/surfactant mixture;
3) neutralizing the resin/surfactant mixture to produce a neutralized mixture;
4) adding water to the neutralized mixture to cause inversion of the neutralized mixture to produce a first resin dispersion; and
5) adding a second resin dispersion to the first resin dispersion in an amount ranging from about 1% to about 40% by weight based on the weight of the total solids in the multi-modal particle size distribution resin dispersion; wherein the second resin dispersion has a particle size sufficient to fit into the interstitial voids of the first resin dispersion.

In another embodiment of this invention, a process is provided to produce the multi-modal particle size distribution resin dispersion. The process comprises: a) contacting a second resin, at least one surfactant, and water to produce a second resin dispersion; and b) adding a first resin dispersion to the second resin dispersion to produce the multi-modal particle size distribution aqueous resin dispersion; wherein the second resin dispersion has a particle size sufficient to fit into the interstitial voids of the first resin dispersion. The second resin, surfactant, and first resin dispersion were previously discussed in this disclosure.

In another embodiment of this invention, a process is provided to produce the multi-modal particle size distribution resin dispersion. The process comprises contacting a second resin, at least one surfactant, water, and a first resin dispersion to produce the multi-modal particle size distribution resin dispersion; wherein the second resin dispersion has a particle size sufficient to fit into the interstitial voids of the first resin dispersion. The second resin, surfactant, and first resin dispersion were previously described in this disclosure.

The first resin dispersion, second resin dispersion, or the inventive multi-modal particle size distribution resin dispersion may also contain plasticizers, antioxidants, stabilizers, biocides, preservatives, and any other additives known in the art for resin dispersions.

Plasticizers can be incorporated into the first resin dispersion, second resin dispersion or multi-modal particle size distribution resin dispersion to aid in the dispersion of the resin. Plasticizers are frequently added to resin dispersion to lower the effective softening point of the resin phase below maximum operating temperatures of equipment used in either the direct or indirect methods. Plasticizers are also added to resin dispersions to improve wetability characteristics of adhesives containing the resin dispersions. To be of utility, a plasticizer must be compatible with the resin and polymer contained in the adhesive. If the plasticizer is incompatible with the resin, the plasticizer will phase-separate and prevent formation of the resin dispersion. If the plasticizer is incompatible with the polymer when the adhesive dries, the plasticizer will migrate to the surface of the dried adhesive thereby reducing performance of the adhesive.

Among the plasticizers of utility in resin dispersions of this invention include liquid or low softening point tackifying resins, petroleum-derived oils, paraffinic oils, napthenic oils, olefin oligomers, low molecular weight polymers, vegetable and animal oils and their derivatives, and mixtures thereof.

At least one antioxidant can be used to protect resin dispersions from oxidation. Hindered bis-phenols can be used for resin dispersions used in applications where minimum staining and discoloration are desired. If discoloration and/or staining is unimportant, an amine-type antioxidant can be used. Antioxidants can be added to the resin, the resin dispersion and/or the adhesive containing the resin dispersion. Antioxidant loading levels are selected based on the Food and Drug Association specified maximum loading levels, desired protection level, and loading cost effectiveness.

Water-soluble resins and gums can be used as stabilizers and thickeners in water-based resin dispersions. Suitable materials used as stabilizers and thickeners would include alkaline polyacrylate solutions, alkali soluble acrylic copolymer emulsions, cellulose derivatives, polyvinyl methyl ether, polyurethane thickeners, polyethylene oxide, natural gums including guar gum, gum Arabic, gum karaya, alginates, casein, and polyvinyl alchol.

Biocides and preservatives can be added to resin dispersions to prevent spoilage. Uncontrolled growth of bacteria in a resin dispersion can affect odor, viscosity, pH, and other properties. Biocides and preservatives are generally added to resin dispersions in the final production phases.

The multi-modal particle size distribution resin dispersion of this invention can be utilized to produce adhesives, pressure sensitive adhesives, coatings, and laminates. Pressure sensitive adhesives (PSAs) are used in a variety of applications including tapes, labels, stickers, decals, decorative vinyls, laminates, and wall coverings.

An adhesive of the invention comprises the multi-modal particle size distribution resin dispersion of the invention and may be prepared by techniques known in the art, e.g. as disclosed in U.S. Pat. Nos. 4,879,333 and 5,728,759, each of which is incorporated in its entirety by reference. For example, the multi-modal particle size distribution resin dispersion of the invention may be coated onto a substrate using techniques known in the art (e.g. roll-coating, curtain coating, gravure coating, slot die coating) to produce an adhesive or coated composition. The substrate can be any common substrate, such as, for example, paper, polyolefin films such as polyethylene and polypropylene, metals such as aluminum and steel, glass, urethane elastomers and primed (painted) substrates, and polyesters, including, but not limited to, terephthalate-based polyesters such as polyethylene terephthalate. The adhesive or coating composition of the invention may be cured at room temperature (ambient cure), at elevated temperatures (thermal cure), or radiation cured.

This invention can be further illustrated by the following examples of preferred embodiments thereof, although it will be understood that these examples are included merely for purposes of illustration and are not intended to limit the scope of the invention unless otherwise specifically indicated.

Test Methods

Particle size diameter was determined by dynamic light scattering. All particle sizes mentioned herein are defined as the predominant diameter present in a peak of the particle size distribution.

### EXAMPLE 1

The reaction vessel made of stainless steel, heated, and equipped with a high torque stainless steel stirrer was used for the emulsification experiments. The temperature inside the reaction vessel was recorded using a thermocouple. Approximately 80 g of a first rosin ester were melted in the reaction vessel to about 110° C. 3.2 grams of anionic ethoxylated surfactant were added to the reactor vessel and mixed at low mixing speeds typically 300 rpm to produce a resin/surfactant mixture. The resin/surfactant mixture was neutralized with 1.8 g of a solution of triethanolamine (TEA, 85%) and stirred until homogenous. Stirring was then slowly increased and kept between 1200 and 2000 rpm.

Demineralized water was preheated and added drop-wise to the resin/surfactant mixture to produce a first resin dispersion. During the addition of water, a viscosity increase was observed. At a certain amount of water, the first resin dispersion inverted from a water-in-oil to an oil-in-water dispersion. A sample of the first resin dispersion was taken to analyze the particle size by dynamic light scattering. The particle size of the first resin dispersion was 450 nm. Beyond the inversion point, a second rosin ester dispersion produced by a batch inversion process and having a small particle size of 100 nm was added to the first resin dispersion to produce a multi-modal particle size distribution resin dispersion. The reactor was cooled down to room temperature at low stirring speeds, and the multi-modal particle size distribution resin dispersion characterized. The total solids of the multi-modal particle size distribution resin dispersion were 63 weight percent, the pH was 6.8, and the viscosity was 380 mPaS. 3)

The total solids of the resin dispersions were determined using a microwave (CEM Labwave-9000 moisture solids analyzer). The viscosity of the resin dispersions were measured using a brookfield viscosity apparatus equipped with spindle number three at 60 RPM.

### EXAMPLE 2

A reaction vessel made of stainless steel, heated, and equipped with a high torque stainless steel stirrer was used for the emulsification experiments. The temperature inside the reaction vessel was recorded using a thermocouple. Approximately 1500 g of a first rosin ester were melted in the vessel to about 110° C. 60.1 grams of anionic ethoxylated surfactant were added to the reactor and mixed at low mixing speeds of typically 60 rpm to produce a resin/surfactant mixture. The resin/surfactant mixture was neutralized with 31.8 g of a solution of triethanolamine (TEA, 85%) and stirred until homogenous. Stirring was then slowly increased and kept between 90 and 95 rpm.

Demineralized water was preheated and added drop-wise to the resin/surfactant mixture to produce a first resin dispersion. During the addition of water, a viscosity increase was observed. At a certain amount of water, the first resin dispersion inverted from a water-in-oil to an oil-in-water dispersion. A sample of the first resin dispersion was taken to analyze the particle size by dynamic light scattering. The particle size of the first resin dispersion was 394 nm. Beyond the inversion point, a second rosin ester dispersion produced by a batch inversion process and having a small particle size of 100 nm and a total solids of 52.4% was added to the first resin dispersion to produce the multi-modal particle size distribution resin dispersion. The total solids of the multi-modal particle size distribution resin dispersion was 64.2 weight percent, and the pH was 6.8. The weight fraction of large particles in the multi-modal particle size distribution resin dispersion was 64.4 weight %

### EXAMPLE 3

The reaction vessel made of stainless steel, heated, and equipped with a high torque stainless steel stirrer was used for the emulsification experiments. The temperature inside the reaction vessel was recorded using a thermocouple. Approximately 1500 g of rosin ester were melted in the reaction vessel to about 110° C. 60.2 grams of anionic ethoxylated surfactant were added to the reactor vessel and mixed at low mixing speeds typically 60 rpm to produce a resin/surfactant mixture. The resin/surfactant mixture was neutralized with 31.8 g of a solution of triethanolamine (TEA, 85%) and stirred until homogenous. Stirring was then slowly increased and kept between 90 and 95 rpm.

Demineralized water was preheated and added drop-wise to the resin/surfactant mixture to produce a first resin dispersion. During the addition of water, a viscosity increase was observed. At a certain amount of water, the first resin dispersion inverted from a water-in-oil to an oil-in-water dispersion. A sample of the first resin dispersion was taken to analyze the particle size by dynamic light scattering. The particle size of the first resin dispersion was 382 nm. Beyond the inversion point, a second rosin ester dispersion produced by a batch inversion process and having a small particle size of 100 nm and 52.4 weight % total solids was added to the first resin dispersion to produce a multi-modal particle size distribution resin dispersion. The reactor was cooled to room temperature at low stirring speeds, and the multi-modal particle size distribution resin dispersion characterized. The total solids of the multi-modal particle size distribution resin dispersion were 65.5 weight percent, and the pH was 7. The weight fraction of large particles in the multi-modal particle size distribution resin dispersion was 79.8 weight %.

### EXAMPLE 4

A reaction vessel made of stainless steel, heated, and equipped with a high torque stainless steel stirrer was used for the emulsification experiments. The temperature inside the reaction vessel was recorded using a thermocouple. Approximately 1500 g of a first rosin ester were melted in the vessel to about 110° C. 54.0 grams of anionic ethoxylated surfactant were added to the reaction vessel and mixed at low mixing speeds typically 60 rpm to produce a resin/surfactant mixture. The resin/surfactant mixture was neutralized with 28.5 g of a solution of triethanolamine (TEA, 85%) and stirred until homogenous. Stirring was then slowly increased and kept between 90 and 95 rpm.

Demineralized water was preheated and added drop-wise to the resin/surfactant mixture to produce a first resin dispersion. During the addition of water, a viscosity increase was observed. At a certain amount of water, the first resin dispersion inverted from a water-in-oil to an oil-in-water dispersion. A sample of the first resin dispersion was taken to analyze the particle size by dynamic light scattering. The particle size of the first resin dispersion was found to be 481 nm. Beyond the inversion point, a second rosin ester dispersion produced by a batch inversion process and having a small particle size of 100 nm and 52.4 weight % total solids was added to the first resin dispersion to produce the multi-modal particle size distribution resin dispersion. The reactor was cooled to room temperature at low stirring speeds, and the multi-modal particle size distribution resin dispersion characterized. The total solids of the multi-modal particle size distribution resin dispersion were 67.4 weight percent, and the pH was 7. The weight fraction of large particles in the multi-modal particle size distribution resin dispersion was 84.1 weight %.

### EXAMPLE 5

The reaction vessel made of stainless steel, heated and equipped with a high torque stainless steel stirrer was used for emulsification experiments. The temperature of the inside of the reaction vessel was recorded using a thermocouple. Approximately 1500 g of a first rosin ester were melted in the reaction vessel to about 110° C. 54.0 grams of anionic ethoxylated surfactant were added to the reactor and mixed at low mixing speeds typically 60 rpm to produce a resin/surfactant mixture. The resin/surfactant mixture was neutralized with 28.7 g of a solution of triethanolamine (TEA, 85%) and stirred until homogenous. Stirring was then slowly increased and kept between 90 and 95 rpm.

Demineralized water was preheated and added drop-wise to the resin/surfactant mixture to produce a first resin dispersion. During the addition of water, a viscosity increase was observed. At a certain amount of water, the first resin dispersion inverted from a water-in-oil to an oil-in-water dispersion. A sample of the first resin dispersion was taken to analyze the particle size by dynamic light scattering. The particle size of the first resin dispersion was 426 nm. Beyond the inversion point, a second rosin ester dispersion produced by a batch inversion process and having a small particle size of 100 nm and 52.4 weight % total solids was added to the first resin dispersion to produce a multi-modal particle size distribution resin dispersion. The reaction vessel was cooled to room temperature at low stirring speeds, and the multi-modal particle size distribution resin dispersion was characterized. The total solids of the multi-modal particle size distribution resin dispersion were 69.8 weight percent, and the pH was 7. The weight fraction of large particles in the multi-modal particle size distribution resin dispersion was 93.7 weight %.

### EXAMPLE 6

The reaction vessel made of stainless steel, heated, and equipped with a high torque stainless steel stirrer. The temperature inside the reaction vessel was recorded using a thermocouple. Approximately 1500 g of a first rosin ester was melted in the vessel to about 110° C. 57.0 grams of an anionic ethoxylated surfactant were added to the reactor and mixed in at low mixing speeds typically 60 rpm to produce a resin/surfactant mixture. The resin/surfactant mixture was neutralized with 30.1 g of a solution of triethanolamine (TEA, 85%) and stirred until homogenous. Stirring was then slowly increased and kept between 90 and 95 rpm.

Demineralized water was preheated and added drop-wise to the resin/surfactant mixture to produce a first resin dispersion. During the addition of water, a viscosity increase was observed. At a certain amount of water, the dispersion inverted from a water-in-oil to an oil-in-water dispersion. A sample of the first resin dispersion was taken to analyze the particle size by dynamic light scattering. The particle size of the first resin dispersion was found to be 922 nm. Beyond the inversion point, a second rosin ester produced by a batch inversion process and having a small particle size of 100 nm and a 52.4% total solids was added to the first resin dispersion to produce the multi-modal particle size distribution resin dispersion. The reaction vessel was cooled to room temperature at low stirring speeds, and the multi-modal particle size distribution resin dispersion characterized. The total solids of the multi-modal particle size distribution resin dispersion was 64.6 weight percent, and pH was 7. The weight fraction of large particles in the multi-modal particle size distribution resin dispersion was 99 weight %.

The invention has been described in detail with particular reference to preferred embodiments thereof, but it will be understood that variations and modifications can be effected within the spirit and scope of the invention.

That which is claimed is:

1. A process for producing a multi-modal particle size distribution resin dispersion comprising contacting a first resin dispersion and a second resin dispersion; wherein said second resin dispersion has a particle size sufficient to fit into the interstitial voids of said first resin dispersion.

2. A process for producing a multi-modal particle size distribution resin dispersion comprising: a) contacting a first resin, at least one surfactant, and water to produce a first resin dispersion; and b) adding a second resin dispersion to said first resin dispersion to produce said multi-modal particle size distribution aqueous resin dispersion; wherein said second resin dispersion has a particle size sufficient to fit into the interstitial voids of said first resin dispersion.

3. A process for producing a multi-modal particle size distribution resin dispersion comprising contacting a first resin, at least one surfactant, water, and a second resin dispersion to produce said multi-modal particle size distribution resin dispersion; wherein said second resin dispersion has a particle size sufficient to fit into the interstitial voids of said first resin dispersion.

4. A process for producing a multi-modal particle size distribution resin dispersion comprising: a) contacting a second resin, at least one surfactant, and water to produce a second resin dispersion; and b) adding a first resin dispersion to said second resin dispersion to produce said multi-modal particle size distribution aqueous resin dispersion; wherein said second resin dispersion has a particle size sufficient to fit into the interstitial voids of said first resin dispersion.

5. A process for producing a multi-modal particle size distribution resin dispersion comprising contacting a second resin, at least one surfactant, water, and a first resin dispersion to produce said multi-modal particle size distribution resin dispersion; wherein said second resin dispersion has a particle size sufficient to fit into the interstitial voids of said first resin dispersion.

6. A process according to claims 1, 2, 3, 4, or 5 for producing a multi-modal particle size distribution resin dispersion further comprising adding at least one other resin dispersion to produce said multi-modal particle size distribution resin dispersion.

7. A process according to claims 1, 2, 3, 4, or 5, wherein said first resin dispersion has a particle size ranging from about 300 to about 2000 nm in diameter.

8. A process according to claim 7 wherein said first resin dispersion has a particle size ranging from about 300 to about 1000 nm in diameter.

9. A process according to claim 8 wherein said first resin dispersion has a particle size ranging from 350 nm to 500 nm.

10. A process according to claims 1, 2, 3, 4, or 5 wherein said first resin is selected from the group consisting of rosins, rosin derivatives, rosin esters, hydrocarbon resins, synthetic polyterpenes, natural terpenes, terpene phenolics, and mixtures thereof.

11. A process according to claim 10 wherein said first resin is selected from the group consisting of (1) natural and modified rosins and the hydrogenated derivatives thereof; (2) esters of natural and modified rosins and the hydrogenated derivatives thereof; (3) polyterpene resins and hydrogenated polyterpene resins; (4) terpene phenolics and derivatives thereof; (5) aliphatic petroleum hydrocarbon resins and the hydrogenated derivatives thereof; (6) aromatic hydrocarbon resins and the hydrogenated derivatives thereof; and (7) alicyclic petroleum hydrocarbon resins and the hydrogenated derivatives thereof.

12. A process according to claim 11 wherein said first resin is at least one rosin ester or at least one hydrocarbon resin.

13. A process according to claim 10 wherein said second resin is selected from the group consisting of rosins, rosin derivatives, rosin esters, hydrocarbon resins, synthetic polyterpenes, natural terpenes, terpene phenolics and mixtures thereof.

14. A process according to claim 13 wherein said second resin is selected from the group consisting of (1) natural and modified rosins and the hydrogenated derivatives thereof; (2) esters of natural and modified rosins and the hydrogenated derivatives thereof; (3) polyterpene resins and hydrogenated polyterpene resins; (4) terpene phenolics and derivatives thereof; (5) aliphatic petroleum hydrocarbon resins and the hydrogenated derivatives thereof; (6) aromatic hydrocarbon resins and the hydrogenated derivatives thereof; and (7) alicyclic petroleum hydrocarbon resins and the hydrogenated derivatives thereof.

15. A process according to claim 10 wherein said second resin dispersion has a particle size ranging from about 50 to about 500 nm.

16. A process according to claim 15 wherein said second resin dispersion has a particle size ranging from about 75 to about 400 nm.

17. A process according to claim 16 wherein said second resin dispersion has a particle size ranging from 100 nm to 300 nm.

18. A process according to claim 10 wherein the softening point of said first resin and second resin ranges from about 30° C. to about 160° C.

19. A process according to claim 18 wherein the softening point of said first resin and said second resin ranges from 50° C. to 90° C.

20. A process according to claim 10 wherein the acid number of said first resin and said second resin ranges from 0 to about 200 grams potassium hydroxide per gram resin.

21. A process according to claim 20 wherein the acid number of said first resin and said second resin ranges from 15 to 70 g KOH/g resin.

22. A process according to claim 10 wherein the amount of said second resin can range from about 0.1% by weight to about 40% by weight based on the weight of the total solids in said multi-modal particle size distribution resin dispersion.

23. A process according to claim 22 wherein the amount of said second resin can range from 10% by weight to 30% by weight based on the weight of the total solids in said multi-modal particle size distribution resin dispersion.

24. A process according to claim 10 wherein said multi-modal particle size distribution resin dispersion has a solids content greater than about 60% by weight.

25. A process according to claim 24 wherein said multi-modal particle size distribution resin dispersion has a solids content ranging from about 60% to about 80%.

26. A process according to claim 10 wherein said first resin dispersion or said second resin dispersion is produced by either a direct or indirect process method.

27. A process according to claim 10 wherein said surfactant is at least one selected from the group consisting of an anionic surfactant and a non-ionic surfactant.

28. A process according to claim 27 wherein said surfactant is selected from the group consisting of alkali alkyl sulfates, alkyl sulfates, alkyl sulfonic acids, fatty acids, alkyl phenol ethoxylates, sulfosuccinates and derivatives, and mixtures thereof.

29. A process to produce a multi-modal particle size distribution resin dispersion, said process comprising contacting (1) a first resin; wherein said first resin comprises at least one rosin having an acid value ranging from about 50 to about 150 and a softening point of from about −25° C. to about 150° C., (2) at least one surfactant in an amount ranging from about 0.1% to about 15% by weight of the total solids of the first resin, (3) water, and (4) a second resin dispersion in an amount ranging from about 1% to about 40% by weight of the total solids of the multi-modal particle size distribution resin dispersion; wherein the particles of the second resin dispersion fit in the interstitial voids of said first resin dispersion.

30. A process to produce a multi-modal particle size distribution resin dispersion, said process comprising:
1) heating a first resin beyond its glass transition temperature to produce a molten first resin; wherein the first resin comprises at least one rosin having an acid value ranging from about 50 to about 150 and a softening point ranging from about −25° C. to about 150° C.;
2) adding at least one surfactant to the molten first resin in an amount ranging from about 0.1% to about 15% by weight based on the weight of the total solids in the first resin to produce a resin/surfactant mixture;
3) neutralizing said resin/surfactant mixture to produce a neutralized mixture;
4) adding water to said neutralized mixture to cause inversion of said neutralized mixture to produce a first resin dispersion; and
5) adding a second resin dispersion to the first resin dispersion in an amount ranging from about 1% to about 40% by weight based on the weight of the total solids in the multi-modal particle size distribution resin dispersion; wherein the second resin dispersion has a particle size sufficient to fit into the interstitial voids of the first resin dispersion.

31. A multi-modal particle size distribution resin dispersion comprising a first resin dispersion and a second resin dispersion; wherein said second resin dispersion has a particle size sufficient to fit into the interstitial voids of said first resin dispersion.

32. A multi-modal particle size distribution resin dispersion according to claim 31 further comprising at least one other resin dispersion to produce said multi-modal particle size distribution resin dispersion.

33. A multi-modal particle size distribution resin dispersion according to claim 31 wherein said first resin dispersion has a particle size ranging from about 300 to about 2000 nm in diameter.

34. A multi-modal particle size distribution resin dispersion according to claim 33 wherein said first resin dispersion has a particle size ranging from about 300 to about 1000 nm in diameter.

35. A multi-modal particle size distribution resin dispersion according to claim 34 wherein said first resin dispersion has a particle size ranging from 350 nm to 500 nm.

36. A multi-modal particle size distribution resin dispersion according to claim 31 wherein said first resin is selected from the group consisting of rosins, rosin derivatives, rosin esters, hydrocarbon resins, synthetic polyterpenes, natural terpenes, terpene phenolics, and mixtures thereof.

37. A multi-modal particle size distribution resin dispersion according to claim 36 wherein said first resin is selected from the group consisting of (1) natural and modified rosins and the hydrogenated derivatives thereof; (2) esters of natural and modified rosins and the hydrogenated derivatives thereof; (3) polyterpene resins and hydrogenated polyterpene resins; (4) terpene phenolics and derivatives thereof; (5) aliphatic petroleum hydrocarbon resins and the hydrogenated derivatives thereof; (6) aromatic hydrocarbon resins and the hydrogenated derivatives thereof; and (7) alicyclic petroleum hydrocarbon resins and the hydrogenated derivatives thereof.

38. A multi-modal particle size distribution resin dispersion according to claim 11 wherein said first resin is at least one rosin ester or at least one hydrocarbon resin.

39. A multi-modal particle size distribution resin dispersion according to claim 31 wherein said second resin is selected from the group consisting of rosins, rosin derivatives, rosin esters, hydrocarbon resins, synthetic polyterpenes, natural terpenes, terpene phenolics, and mixtures thereof.

40. A multi-modal particle size distribution resin dispersion according to claim 39 wherein said second resin is selected from the group consisting of (1) natural and modified rosins and the hydrogenated derivatives thereof; (2) esters of natural and modified rosins and the hydrogenated derivatives thereof; (3) polyterpene resins and hydrogenated polyterpene resins; (4) terpene phenolics and derivatives thereof; (5) aliphatic petroleum hydrocarbon resins and the hydrogenated derivatives thereof; (6) aromatic hydrocarbon resins and the hydrogenated derivatives thereof; and (7) alicyclic petroleum hydrocarbon resins and the hydrogenated derivatives thereof.

41. A multi-modal particle size distribution resin dispersion according to claim 31 wherein said second resin dispersion has a particle size ranging from about 50 to about 500 nm.

42. A multi-modal particle size distribution resin dispersion according to claim 41 wherein said second resin dispersion has a particle size ranging from about 75 to about 400 nm.

43. A multi-modal particle size distribution resin dispersion according to claim 42 wherein said second resin dispersion has a particle size ranging from 100 nm to 300 nm.

44. A multi-modal particle size distribution resin dispersion according to claim 31 wherein the softening point of said first resin and second resin ranges from about 30° C. to about 160° C.

45. A multi-modal particle size distribution resin dispersion according to claim 44 wherein the softening point of said first resin and said second resin ranges from 50° C. to 90° C.

46. A multi-modal particle size distribution resin dispersion according to claim 31 wherein the acid number of said first resin and said second resin ranges from 0 to about 200 grams potassium hydroxide per gram resin.

47. A multi-modal particle size distribution resin dispersion according to claim 46 wherein the acid number of said first resin and said second resin ranges from 15 to 70 g KOH/g resin.

48. A multi-modal particle size distribution resin dispersion according to claim 31 wherein the amount of said second resin can range from about 0.1% by weight to about 40% by weight based on the weight of the total solids in the multi-modal particle size distribution resin dispersion.

49. A multi-modal particle size distribution resin dispersion according to claim 48 wherein the amount of said second resin can range from 10% by weight to 30% by weight based on the weight of the total solids in the multi-modal particle size distribution resin dispersion.

50. A multi-modal particle size distribution resin dispersion according to claim 31 wherein said multi-modal particle size distribution resin dispersion has a solids content greater than about 60% by weight.

51. A multi-modal particle size distribution resin dispersion according to claim 50 wherein said multi-modal particle size distribution resin dispersion has a solids content ranging from about 60% to about 80%.

52. A multi-modal particle size distribution resin dispersion according to claim 31 wherein said first resin dispersion or said second resin dispersion is produced by either a direct or indirect process method.

53. A multi-modal particle size distribution resin dispersion according to claim 31 wherein said surfactant is at least one selected from the group consisting of an anionic surfactant and a non-ionic surfactant.

54. A multi-modal particle size distribution resin dispersion according to claim 53 wherein said surfactant is selected from the group consisting of alkali alkylsulfate, ammonium alkysulfate, alkylsulfonic acid, fatty acid, oxyethylated alkyphenol, sulfosuccinates and derivatives, and mixtures thereof.

55. A multi-modal particle size distribution resin dispersion produced by the process of claims 1, 2, 3, 4, or 5.

56. An adhesive comprising said multi-modal particle size distribution resin dispersion in claims 31 or 55.

57. An article comprising said adhesive in claim 56.
